(19) United States
(12) Patent Application Publication
(10) Pub. No.: US 2008/0008171 A1
(43) Pub. Date: Jan. 10, 2008

(54) SYSTEM AND METHOD FOR DETECTING AND INTERCEPTION OF IP SHARER

(75) Inventors: YOUNG-SOO CHOI, DAEJEON-CITY (KR); BYEONG-SOOK BAE, DAEJEON-CITY (KR); JAE-DONG KIM, DAEJEON-CITY (KR); EUN-HO KIM, DAEJEON-CITY (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY (KR)

(21) Appl. No.: 11/770,417

(22) Filed: Jun. 28, 2007

Related U.S. Application Data
(63) Continuation of application No. PCT/KR2005/004595, filed on Dec. 28, 2005.

(30) Foreign Application Priority Data
Dec. 28, 2004 (KR) 10-2004-0113950

(51) Int. Cl. H04L 12/56

(52) U.S. Cl. 370/389

(57) ABSTRACT

Disclosed is an IP sharer detecting and intercepting system and method. According to the IP sharer detecting and intercepting method, all the IP packets transmitted through the network are detected, an ID value of the IP header is extracted from the detected IP packets, and an IP sharer user is estimated based on the number of states of ID values for the same IP. A notice packet is transmitted to the estimated IP sharer user to detect a private IP of the IP sharer user, it is determined whether the IP sharer user uses the IP sharer based on the detected private IP, and the checked IP sharer user's Internet connection is intercepted. In this instance, a notice packet for introducing an entrance to a normal cable is generated to the IP sharer user before the checked IP sharer user's Internet connection is intercepted.

### CROSS-REFERENCE TO RELATED PATENT APPLICATIONS

This application is a continuation application under 35 U.S.C. § 365(c) of International Application No. PCT/KR2005/004595, filed Dec. 28, 2005 designating the United States. International Application No. PCT/KR2005/004595 was published in English as WO2006/071065 A1 on Jul. 6, 2006. This application further claims the benefit of the earlier filing dates under 35 U.S.C. § 365(b) of Korean Patent Application No. 10-2004-0113950 filed Dec. 28, 2004. This application incorporates herein by reference the International Application No. PCT/KR2005/004595 including the International Publication No. WO2006/071065 A1 and the Korean Patent Application No. 10-2004-0113950 in their entirety.

### BACKGROUND

1. Field

The present disclosure relates to a system and method for detecting and intercepting an IP sharer. More specifically, the present disclosure relates to a system and method for detecting and intercepting an IP sharer for detecting IP sharer users and intercepting a service provided to an illegal IP sharer user.

2. Discussion of the Related Technology

In the contemporary knowledge and information society, it has become possible for everyone to easily access various web sites of all the countries in the world through the Internet, and the Internet has changed from a low speed and high expense service to one of high speed and low cost, thereby enabling the development of high-quality Internet services. Further, Internet service providers (ISPs) that provide high-quality services now also provide the Internet services through high-speed networks to general homes including large apartment complexes so as to satisfy the requirements of users who need the same in their homes.

Recently, the usage of network address translator (NAT) type of sharers for sharing the sharers by a plurality of network devices by using a single high-speed Internet cable provided by an ISP has been substantially increased.

The NAT scheme was originally developed for the purpose of protecting subnetworks against external attacks. That is, the real IP address allocated to a computer cannot be known to the outside, and no hacking or cracking is possible. Hence, very few methods for an outsider to attempt to know internal users of the NAT type of IP sharer are possible.

However, the method for controlling a plurality of computers to use a single certified IP and accordingly use the Internet by using the NAT scheme has been recently used as a core technique of the IP sharer.

As IP sharing has increased, the number of high-speed Internet users has also increased, and traffic is accordingly increased. The increase of traffic causes transmission delays of users and thereby degrades the quality of the service. That is, when it is assumed that an average of 500K-bit traffic is generated for each user and the concurrent traffic generation rate is given to be 12%, transmission delay is doubled or tripled if 10% of users use the traffic with the averaged IP sharing rate of five users. In this instance, the transmission delay is increased up to 4.3 times when the concurrent access rate is given as 15%. Therefore, while the 10% of users can acquire advantages through saving of usage fees by sharing the IP, this degrades the quality of service of the other 90% of users.

The foregoing discussion in this section is to provide general background information, and does not constitute an admission of prior art.

### SUMMARY

An aspect of the present invention provides an IP sharer detecting and intercepting system and method for intercepting the service provided to illegal IP sharer users by detecting the IP sharer users in order to prevent degradation of quality of service for users.

In one aspect of the present invention, in a system for detecting an IP sharer and intercepting the detected IP sharer user's Internet connection, the IP sharer for providing Internet services to a plurality of PCs by using a certified IP, a system for detecting and intercepting an IP sharer includes: a packet detector for detecting all IP packets transmitted through a network; an ID analyzer for extracting an ID value of an ID header from the detected IP packet, and estimating IP sharer users based on the number of states of ID values on the same IP; a sharer database for storing an IP address allocated to an IP sharer estimated by the packet detector and user information corresponding to the IP address; a notice transmitter for generating a notice packet on the estimated IP sharer user and transmitting the generated notice packet according to a notice transmission rule; a private IP detector for detecting a private IP established to the PC when the transmitted notice packet is output to the IP sharer user's PC; and a subscriber interceptor for checking whether the IP sharer user uses the IP sharer based on the detected private IP, and intercepting the usage of Internet.

In another aspect of the present invention, in a method for detecting an IP sharer that provides an Internet service to a plurality of PCs by using a certified IP, and intercepting the detected IP sharer user's Internet connection, the method includes: a) detecting all IP packets transmitted through a network; b) extracting an ID value of an IP header from the detected IP packet, and estimating an IP sharer user based on the number of states of ID values for the same IP; c) transmitting a notice packet to the estimated IP sharer user, and detecting a private IP of the IP sharer user; d) checking whether the IP sharer user uses the IP sharer based on the detected private IP; and e) intercepting the checked IP sharer user's Internet connection.

### DESCRIPTION OF THE DRAWINGS

FIG. 1 shows a configuration of an IP sharer detecting and intercepting system according to an embodiment of the present invention.

FIG. 2 shows an operational process of an IP sharer detecting and intercepting system according to an embodiment of the present invention.

### DETAILED DESCRIPTION OF EMBODIMENTS

In the following detailed description, embodiments of the invention will be shown and described. As will be realized, embodiments of the invention would be modified in various obvious respects, all without departing from the scope of the invention. Accordingly, the drawings and description are to be regarded as illustrative in nature, and not restrictive.

An IP sharer detecting and intercepting system and method according to an embodiment of the present invention will be described in detail with reference to drawings.

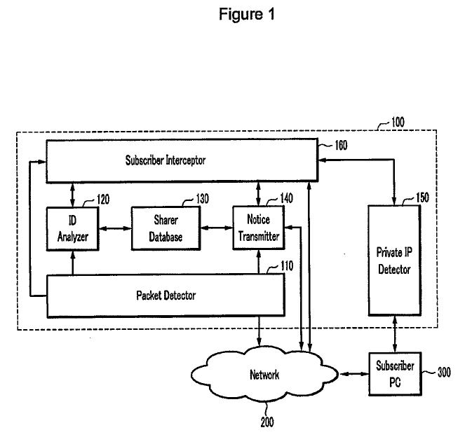

Initially, an IP sharer detecting and intercepting system according to an embodiment of the present invention will be described in detail with reference to FIG. 1. FIG. 1 shows a configuration of an IP sharer detecting and intercepting system according to an embodiment of the present invention.

As shown in FIG. 1, the IP sharer detecting and intercepting system 100 includes a packet detector 110, an identification (ID) analyzer 120, a sharer database 130, a notice transmitter 140, a private IP detector 150, and a subscriber interceptor 160.

The packet detector 110 extracts all IP packets on the Ethernet transmitted through a network 200, and transmits the IP packets to the ID analyzer 120, the notice transmitter 140, and the subscriber interceptor 160. In this instance, the packet detector 110 transmits all the IP packets to the ID analyzer 120, transmits packets having the destination port of TCP packets of number 80 from among the TCP packets from among all the IP packets to the notice transmitter 140, and also transmits all the TCP packets from among all the packets to the subscriber interceptor 160.

The ID analyzer 120 extracts an ID value of an IP header of the IP packet transmitted from the packet detector 110, checks states of ID values generated with respect to the same IP, and determines whether to use a first IP sharer.

The sharer database 130 stores an IP address allocated to the IP sharer detected by the ID analyzer 120, and subscriber information corresponding to the IP address. The subscriber information may include a subscriber name, a subscriber ID, and a number of sharer-connected PCs.

The notice transmitter 140 receives the packets that use the TCP port of the number 80 from the packet detector 110, and generates a notice packet for an HTTP connection setting request.

The private IP detector 150 detects a private IP on the subscriber PC from the notice packet transmitted by the notice transmitter 140.

The subscriber interceptor 160 checks whether a first IP sharer user uses an IP sharer based on the private IP detected by the private IP detector 150. The subscriber interceptor 160 analyzes all the TCP packets transmitted by the packet detector 110 with respect to the checked IP sharer user, and intercepts the Internet connection.

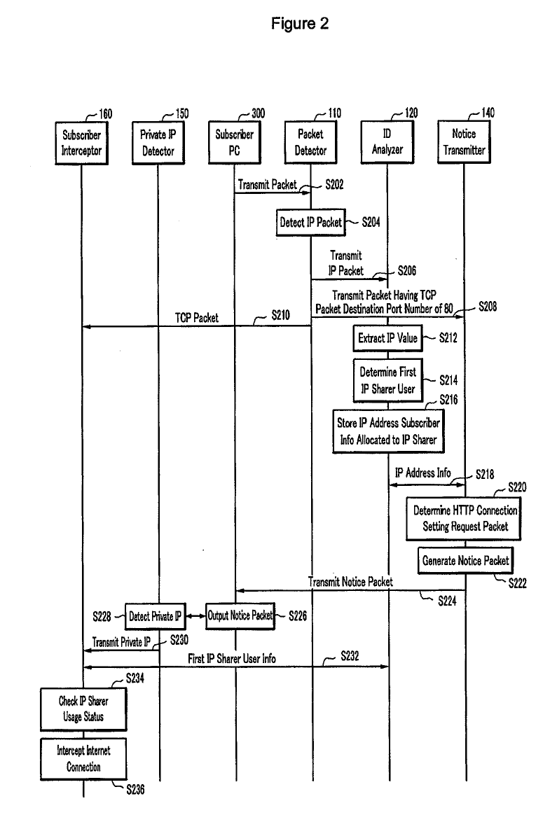

An operation of the IP sharer detecting and intercepting system according to an embodiment of the present invention will now be described with reference to FIG. 2. FIG. 2 shows an operational process of an IP sharer detecting and intercepting system according to an embodiment of the present invention.

As shown in FIG. 2, the packet detector 110 of the IP sharer detecting and intercepting system 100 detects all the IP packets on the Ethernet transmitted through the network 200 in steps S202 and S204, transmits all the IP packets to the ID analyzer 120 in step S206, transmits packets having the destination port of TCP packets of number 80 of the TCP packets from among all the IP packets to the notice transmitter 140 in step S208, and transmits all the TCP packets from among all the packets to the subscriber interceptor 160 in step S210.

First, the ID analyzer 110 extracts an ID value of the IP header of the IP packet from the packet detector 110 in step S212, and determines the user to be a first IP sharer user and defines the number of states to be the number of concurrently used PCs connected to the IP sharer in step S214 when at least two ID values are generated for the same IP, and the ID analyzer 110 stores the IP address allocated to the initially detected IP sharer and corresponding subscriber information in the sharer database 130 in step S216.

When receiving the packet that uses the same IP address as that of the IP sharer user in the sharer database 130 from the IP packet transmitted by the packet detector 110, the notice transmitter 140 determines whether the packet is an HTTP connection setting request packet in steps S218 and S220. In this instance, the HTTP connection setting request packet can be determined to be a packet having the number of the destination port of the TCP packet as the number 80. When the packet is the HTTP connection setting request packet, the notice transmitter 140 generates a notice transmittable HTTP packet in a format corresponding to the received HTTP connection setting request packet, and transmits the notice packet to the subscriber PC 300 through the network 200 according to a predetermined notice transmission rule in steps S222 and S224.

The private IP detector 150 detects, in step S228, a private IP that is included in the notice packet transmitted to the subscriber PC 300 from the notice transmitter 140, that is operated when the notice is output to the web browser of the PC 300 in step S226, and that is established in the subscriber PC 300, and the private IP detector 150 transmits the detected private IP to the subscriber interceptor 160 in step S230.

The subscriber interceptor 160 checks whether the first IP sharer user uses the IP sharer in steps S232 and S234 based on the private IP detected by the private IP detector 150, and intercepts the checked IP sharer user's Internet connection in step S236. That is, when the TCP port numbers of all the TCP packets transmitted by the packet detector 110 the subscriber interceptor 160 is given to be the number 80, the subscriber interceptor 160 checks packets in which the TCP code bit is an acknowledgment (ACK), or an ACK and a push (PSH), detects an HTTP connection setting request packet, generates an Internet interception packet including contents for intercepting a corresponding HTTP connection, and transmits the same to the subscriber PC 300 through the network 200. Also, in the case of the packets having the TCP port number to be other than 80, the subscriber interceptor 160 checks packets having the TCP code bit of SYN, generates an Internet interception packet for intercepting the Internet connection, and transmits the Internet interception packet to the subscriber PC 300 through the network 200. In this instance, the TCP SYN packet is an access connection request packet that is transmitted for synchronizing a sequence number, the ACK packet is a packet for informing receipt of the corresponding packet, and the PSH packet is a data transmission packet.

Further, it is possible to transmit a notice packet for introducing entrance to a normal cable to the IP sharer user through the notice transmitter 140 without intercepting the checked IP sharer user's Internet connection. When a packet having the same IP address is detected after a predetermined time frame after the notice packet is transmitted, the subscriber interceptor 160 can intercept the IP sharer user's Internet connection.

The above-configured IP sharer detecting and intercepting system is operable automatically or manually.

While embodiments of the invention have been described, it is to be understood that the invention is not limited to the disclosed embodiments.

According to embodiments of the present invention, the sharer users can be efficiently detected and intercepted on the huge ISP network and the users can be efficiently managed by detecting the sharer at important points of the IP network and automatically intercepting the detected sharer.

What is claimed is:

1. A system for monitoring an IP sharer for providing Internet services to a plurality of PCs by using a certified IP address, comprising:
a sharer database for storing information on an estimated IP sharer user, the information including an IP address allocated to the IP sharer of the estimated IP sharer user;
a packet detector for detecting all IP packets transmitted from a subscriber PC to a network;
an ID analyzer for extracting an ID value from an ID header of the IP packet transmitted from the packet detector, detecting an ID value flow generated for the same IP address, and when a flow of a plurality of ID values is generated for the same IP address, estimating the corresponding IP address to be an IP address of the IP sharer user, and storing estimated IP sharer user information in the sharer database;
a notice transmitter for generating a notice packet for detecting an IP address established in the PC of the estimated IP sharer user, and transmitting the generated notice packet to the PC of the estimated IP sharer user;
a private IP address detector for detecting an IP address established in the PC when the transmitted notice packet is output to the PC; and
a subscriber interceptor for checking whether the estimated IP sharer user uses the IP sharer based on the detected IP address.

2. The system of claim 1, wherein the subscriber interceptor intercepts the estimated IP sharer user's Internet use according to the checking result on the IP sharer use.

3. The system of claim 2, wherein the packet detector transmits the detected IP packets to the ID analyzer, transmits a first packet that is a TCP packet from among the detected IP packets to the subscriber interceptor, and transmits a second packet that is a TCP packet having a destination port as a specific port number from among the detected IP packets to the notice transmitter.

4. The system of claim 2, wherein a packet for introducing a subscription through a normal line is generated and is transmitted to the PC by the notice transmitter before the Internet use is intercepted.

5. The system of claim 1, wherein the packet detector transmits the detected IP packets to the ID analyzer, transmits a first packet that is a TCP packet from among the detected IP packets to the subscriber interceptor, and transmits a second packet that is a TCP packet having a destination port as a specific port number from among the detected IP packets to the notice transmitter.

6. The system of claim 5, wherein the notice transmitter determines whether the TCP packet is an Internet connection setting request packet including a specific destination port number, and generates a notice packet corresponding to the determined Internet connection setting request packet when the IP address of the second packet corresponds to the IP address allocated to the IP sharer.

7. The system of claim 5, wherein the subscriber interceptor checks specific bit information of the first packet to detect the Internet connection setting request packet, generates an Internet interception packet corresponding to the detected Internet connection setting request packet, and transmits the Internet interception packet to the PC, the bit information including ACK (Acknowledgment field significant), PSH (Push function), and SYN (Synchronize sequence number).

8. A method for monitoring an IP sharer for providing Internet services to a plurality of PCs by using a certified IP address, comprising:
a) detecting IP packets transmitted from a subscriber PC to a network;
b) extracting an ID value of an IP header from the detected IP packet, detecting an ID value flow generated for the same IP address, and when a flow of a plurality of ID values is generated for the same IP address, estimating the corresponding IP address as an IP address of the IP sharer user, and storing user information including an IP address allocated to the IP sharer of the estimated IP sharer user;
c) transmitting a notice packet for detecting the IP address established to the PC of the estimated IP sharer user, and detecting a private IP established to the PC when the transmitted notice packet is output to the PC; and
d) checking whether the estimated IP sharer user uses the IP sharer based on the detected private IP address.

9. The method of claim 8, further comprising, after d), intercepting the checked IP sharer user's Internet connection according to the checking result.

10. The method of claim 9, further comprising, after d), generating and transmitting a packet for introducing a subscription through a normal line before the Internet use is intercepted.

11. The method of claim 9, wherein c) comprises:
generating a notice packet corresponding to an Internet connection setting request packet having a specific destination port number from among the IP packets detected in a);
transmitting the generated notice packet according to a predetermined notice transmission rule; and
starting an operation and detecting a private IP address when the transmitted notice packet is output on a web browser of the PC.

12. The method of claim 9, wherein e) comprises:
e-1) checking a code bit of the TCP packet included by the IP packet detected in a), and extracting an Internet connection setting request packet, the code bit being ACK (Acknowledgment field significant), PSH (Push function), and SYN (Synchronize sequence number) included in the TCP packet;
e-2) generating an Internet interception packet for intercepting the Internet connection in correspondence to the extracted Internet connection setting request packet; and
e-3) transmitting the generated Internet interception packet to the checked IP sharer user, and intercepting the Internet.

13. The method of claim 12, wherein e-1) comprises checking the ACK or the PSH of the code bit when the port number of the TCP packet is given to be 80, and checking the SYN of the code bit when the port number is not 80.

14. The method of claim 8, wherein c) comprises:
generating a notice packet corresponding to an Internet connection setting request packet having a specific destination port number from among the IP packets detected in a);
transmitting the generated notice packet according to a predetermined notice transmission rule; and
starting an operation and detecting a private IP address when the transmitted notice packet is output on a web browser of the PC.
